(19) United States
(12) Patent Application Publication
(10) Pub. No.: US 2021/0326831 A1
(43) Pub. Date: Oct. 21, 2021

(54) System, Method, and Apparatus for Multiple Transaction Accounts

(71) Applicant: Visa International Service Association, San Francisco, CA (US)

(72) Inventor: Mohammad Al-Bedaiwi, Round Rock, TX (US)

(21) Appl. No.: 16/854,164

(22) Filed: Apr. 21, 2020

(51) Int. Cl. G06Q 20/22; G06Q 20/40; G06Q 40/02

(52) U.S. Cl. CPC G06Q 20/227; G06Q 40/02; G06Q 20/407

(57) ABSTRACT

Described herein are systems, methods, and apparatuses for multiple transaction accounts. The systems, methods, and apparatuses may include a payment network receiving a multiple account eligibility check request message, determining whether a first account is eligible for multiple account transactions with a second account, sending a multiple account transaction eligibility confirmation message, receiving an authorization request message, sending the authorization request message, receiving an authorization response message, forwarding the authorization response message to an access device, executing a pull funds operation from the second account, and executing a push funds operation to the first account.

### BACKGROUND

### 1. Technical Field

This disclosure pertains to payment transactions involving multiple accounts conducted using a single payment device and further involving a system of automated reimbursements between those accounts.

### 2. Technical Considerations

Electronic payment technology, including credit cards and debit cards are widely used in performing transactions for goods and services. However, when a consumer wishes to use different payment accounts, they must typically carry a payment device for each account. This is especially true for certain special or limited-purpose accounts and payment devices, like healthcare flexible spending account (“FSA”) cards or government assistance program accounts and payment devices, such as electronic benefit transfer (“EBT”) cards. What is needed is a system, method, and apparatus for associating a first account with a second account, and enabling an initial transaction using the first account, with subsequent automated reimbursement from the second account.

### SUMMARY

Non-limiting examples or aspects of the disclosure are directed to systems, methods, and apparatuses for performing a transaction using an account credential, determining whether a second account is associated with the account credential, and providing a cardholder an option to transact using funds associated with the second account. A benefit of the non-limiting examples or aspects disclosed herein include enabling a cardholder to rely on one payment card to perform transactions using accounts issued by more than one issuer and/or limited purpose reimbursement-based accounts, such as healthcare flexible spending accounts (“FSAs”), health savings accounts (“HSAs”), electronic benefit transfer accounts (“EBTs”), education savings plan accounts such as “529” plans, retirement accounts, and accounts that do not issue individual payment cards. An addition benefit of the non-limiting examples or aspects disclosed herein includes removing the need for the aforementioned limited purpose reimbursement-based accounts to issue physical payment cards. Further benefits include minimizing the amount of payment kernel software required to reside on point-of-sale terminals, and consequently, minimizing or reducing the number of certifications required for such point of sale terminals.

According to some non-limiting examples or aspects, provided is a multiple account transaction method comprising; receiving, by an access device, a first account number; sending, by the access device, a multiple account eligibility check request message comprising the first account number; receiving, by the access device, a multiple account eligibility confirmation message comprising at least one multiple account identifier; displaying, by the access device, the at least one multiple account identifier; receiving, by the access device, a selection input; generating, by the access device, an authorization request message based upon the selection input, wherein the authorization request message comprises a multiple account transaction flag and a transaction amount; sending, by the access device, the authorization message; and receiving, by the access device, an authorization response message.

In some non-limiting examples or aspects, the at least one multiple account identifier is an indicator that a second account number is associated with the first account number.

In some non-limiting examples or aspects, the second account number corresponds to at least one of a healthcare flexible spending account (“FSA”), a health savings account (“HSA”), an electronic benefit transfer account (“EBT”), an education savings plan account, or any combination thereof.

In some non-limiting examples or aspects, the method further comprises determining whether an item is eligible for purchase using the second account number.

In some non-limiting examples or aspects, the authorization request message further comprises a reimbursement amount that is less than or equal to the transaction amount.

In some non-limiting examples or aspects, the at least one multiple account identifier is the multiple account transaction flag.

In some non-limiting examples or aspects, the authorization request message and the authorization response message are formatted according to a messaging specification, as defined in ISO 8583.

In some non-limiting examples or aspects, the step of receiving, by the access device, the first account number, comprises performing an interaction between a payment device and the access device.

In some non-limiting examples or aspects, the interaction comprises at least one of reading a magnetic stripe of the payment device, reading an integrated circuit of the payment device, communicating wirelessly with the payment device, or any combination thereof.

According to some non-limiting examples or aspects, provided is a multiple account transaction method comprising; receiving, by a payment network, a multiple account eligibility check request message comprising a first account number associated with a first account; determining, by the payment network, whether the first account is eligible for multiple account transactions with a second account number associated with a second account; sending, by the payment network, a multiple account transaction eligibility confirmation message; receiving, by the payment network, an authorization request message for a transaction including a multiple account transaction flag and a reimbursement amount; sending, by the payment network, the authorization request message to an issuer; receiving, by the payment network, an authorization response message; forwarding, by the payment network, the authorization response message to an access device; and in response to the authorization response message indicating transaction approval: executing, by the payment network, a pull funds operation from the second account for the reimbursement amount; and executing, by the payment network, a push funds operation to the first account for the reimbursement amount.

In some non-limiting examples or aspects, the first account and the second account are both associated with an account holder.

In some non-limiting examples or aspects, the authorization request message and the authorization response message are formatted according to a messaging specification, as defined in ISO 8583.

In some non-limiting examples or aspects, the method further comprises retrieving, by the payment network, the second account number when the multiple account transaction flag is set.

In some non-limiting examples or aspects, the pull funds operation is an account funding transaction (“AFT”) and the push funds operation is an original credit transaction (“OCT”).

In some non-limiting examples or aspects, the second account is at least one of a healthcare flexible spending account (“FSA”), a health savings account (“HSA”), an electronic benefit transfer account (“EBT”), an education savings plan account, or any combination thereof.

In some non-limiting examples or aspects, the method further comprises determining whether an item associated with the transaction is eligible for purchase using the second account.

According to some non-limiting examples or aspects, provided is a system for performing a multiple account transaction method, comprising; an access device; and a payment network configured to: receive a multiple account eligibility check request message comprising a first account number associated with a first account; determine whether the first account is eligible for multiple account transactions with a second account number associated with a second account; send a multiple account transaction eligibility confirmation message comprising at least a multiple account identifier; receive an authorization request message for a transaction including a multiple account transaction flag; send the authorization request message to an issuer; receive an authorization response message; forward the authorization response message to an access device, and if the authorization response message indicates transaction approval: execute a pull funds operation from the second account; and execute a push funds operation to the first account; wherein the access device is configured to: receive the first account number associated with the first account; send the multiple account eligibility check request message comprising the first account number; receive the multiple account transaction eligibility confirmation message; display the multiple account identifier; receive a selection input; generate the authorization request message based upon the selection input; send the authorization request message; and receive an authorization response message.

In some non-limiting examples or aspects, the pull funds operation is an account funding transaction (“AFT”) and the push funds operation is an original credit transaction (“OCT”).

In some non-limiting examples or aspects, the second account is at least one of a healthcare flexible spending account (“FSA”), a health savings account (“HSA”), an electronic benefit transfer account (“EBT”), an education savings plan account, or any combination thereof.

In some non-limiting examples or aspects, the authorization request message and the authorization response message are formatted according to a messaging specification, as defined in ISO 8583.

Further non-limiting examples or aspects are set forth in the following numbered clauses:

Clause 1: A multiple account transaction method, comprising: receiving, by an access device, a first account number; sending, by the access device, a multiple account eligibility check request message comprising the first account number; receiving, by the access device, a multiple account eligibility confirmation message comprising at least one multiple account identifier; displaying, by the access device, the at least one multiple account identifier; receiving, by the access device, a selection input; generating, by the access device, an authorization request message based upon the selection input, wherein the authorization request message comprises a multiple account transaction flag and a transaction amount; sending, by the access device, the authorization request message; and receiving, by the access device, an authorization response message.

Clause 2: The method of clause 1, wherein the at least one multiple account identifier is an indicator that a second account number is associated with the first account number.

Clause 3: The method of clauses 1 or 2, wherein the second account number corresponds at least one of a healthcare flexible spending account (“FSA”), a health savings account (“HSA”), an electronic benefit transfer account (“EBT”), an education savings plan account, or any combination thereof.

Clause 4: The method of any of clauses 1-3 further comprising determining whether an item is eligible for purchase using the second account number.

Clause 5: The method of any of clauses 1-4, wherein the authorization request message further comprises a reimbursement amount that is less than or equal to the transaction amount.

Clause 6: The method of any of clauses 1-5, wherein the at least one multiple account identifier is the multiple account transaction flag.

Clause 7: The method of any of clauses 1-6, wherein the authorization request message and the authorization response message are formatted according to a messaging specification, as defined in ISO 8583.

Clause 8: The method of any of clauses 1-7, wherein the step of receiving, by the access device, the first account number, comprises performing an interaction between a payment device and the access device.

Clause 9: The method of any of clauses 1-8, wherein the interaction comprises at least one of reading a magnetic stripe of the payment device, reading an integrated circuit of the payment device, communicating wirelessly with the payment device, or any combination thereof.

Clause 10: A multiple account transaction method, comprising: receiving, by a payment network, a multiple account eligibility check request message comprising a first account number associated with a first account; determining, by the payment network, whether the first account is eligible for multiple account transactions with a second account number associated with a second account; sending, by the payment network, a multiple account transaction eligibility confirmation message; receiving, by the payment network, an authorization request message for a transaction including a multiple account transaction flag and a reimbursement amount; sending, by the payment network, the authorization request message to an issuer; receiving, by the payment network, an authorization response message; forwarding, by the payment network, the authorization response message to an access device; and in response to the authorization response message indicating transaction approval: executing, by the payment network, a pull funds operation from the second account for the reimbursement amount; and executing, by the payment network, a push funds operation to the first account for the reimbursement amount.

Clause 11: The method of clause 10, wherein the first account and the second account are both associated with an account holder.

Clause 12: The method of clauses 10 or 11, wherein the authorization request message and the authorization response message are formatted according to a messaging specification, as defined in ISO 8583

Clause 13: The method of any of clauses 10-12, further comprising retrieving, by the payment network, the second account number when the multiple account transaction flag is set.

Clause 14: The method of any of clauses 10-13, wherein the pull funds operation is an account funding transaction (“AFT”) and the push funds operation is an original credit transaction (“OCT”).

Clause 15: The method of any of clauses 10-14 wherein the second account is at least one of a healthcare flexible spending account (“FSA”), a health savings account (“HSA”), an electronic benefit transfer account (“EBT”), an education savings plan account, or any combination thereof.

Clause 16: The method of any of clauses 10-15 further comprising: determining whether an item associated with the transaction is eligible for purchase using the second account.

Clause 17: A system for performing a multiple account transaction method, the system comprising: an access device; and a payment network configured to: receive a multiple account eligibility check request message comprising a first account number associated with a first account; determine whether the first account is eligible for multiple account transactions with a second account number associated with a second account; send a multiple account transaction eligibility confirmation message comprising at least a multiple account identifier; receive an authorization request message for a transaction including a multiple account transaction flag; send the authorization request message to an issuer; receive an authorization response message; forward the authorization response message to an access device, and if the authorization response message indicates transaction approval: execute a pull funds operation from the second account; and execute a push funds operation to the first account; wherein the access device is configured to: receive the first account number associated with the first account; send the multiple account eligibility check request message comprising the first account number; receive the multiple account transaction eligibility confirmation message; display the multiple account identifier; receive a selection input; generate the authorization request message based upon the selection input; send the authorization request message; and receive an authorization response message.

Clause 18: The system of clause 17, wherein the pull funds operation is an account funding transaction (“AFT”) and the push funds operation is an original credit transaction (“OCT”).

Clause 19: The system of clauses 17 or 18, wherein the second account is at least one of a healthcare flexible spending account (“FSA”), a health savings account (“HSA”), an electronic benefit transfer account (“EBT”), an education savings plan account, or any combination thereof.

Clause 20: The system of any of clauses 17-19, wherein the authorization request message and the authorization response message are formatted according to a messaging specification, as defined in ISO 8583.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 depicts an illustrative non-limiting example of a system for conducting a multiple account transaction in accordance with some non-limiting examples or aspects of the present disclosure.

FIG. 2 depicts an illustrative non-limiting example of a decision tree for implementing a system, method, and/or process in accordance with some non-limiting examples or aspects of the present disclosure.

FIG. 3 depicts an illustrative non-limiting example of sequence diagram for implementing a system, method, and/or process in accordance with some non-limiting examples or aspects of the present disclosure.

FIG. 4 depicts an illustrative non-limiting example of an association between a first account number, a second account number, and an associated account type and reimbursement method in accordance with some non-limiting examples or aspects of the present disclosure.

FIG. 5 depicts an illustrative non-limiting example of a user interface displayed on an access device when conducting a multiple account transaction in accordance with some non-limiting examples or aspects of the present disclosure.

### DETAILED DESCRIPTION

In the following description, various non-limiting examples or aspects will be described. For purposes of explanation, specific configurations and details are set forth in order to provide a thorough understanding of some non-limiting examples or aspects. However, it will also be apparent to one skilled in the art that the non-limiting examples or aspects may be practiced without the specific details. Furthermore, well-known features may be omitted or simplified in order not to obscure the non-limiting examples or aspects being described. Prior to discussing non-limiting examples or aspects of the disclosure, description of some terms may be helpful in understanding these non-limiting examples or aspects.

As used herein, the term “access device” may be any suitable device that can accept or initiate a transaction. An access device may also be used for communicating with a merchant server, a transaction processing computer, an authentication computer, a payment network, a financial institution, or any other suitable system. An access device may be either mobile or stationary, and may contain a variety of methods for receiving input from a payment device, such as contactless, magstripe, EMV chip, and any other suitable technique. An access device may also contain input/output devices for customer interaction. An access device may contain a “PIN pad” for entering a personal identification number, and may also accept tactile input via a touch-screen display. Non-limiting examples of an access device may include a point of sale system or terminal, cash register, or a merchant server, such as a web server or e-commerce payment gateway configured to receive payment or transaction information.

As used herein, the term “account credential,” “account number,” or “payment credential” may refer to any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Such information may also include representations of, or proxies for, the aforementioned information, such as a payment token.

As used herein, the term “authorization request message” may refer to a message sent to request an authorization for a transaction. An authorization request message may comply with ISO 8583, which is a standard for the exchange of message in a financial transaction system. An authorization request message according to other examples may comply with other suitable standards. An authorization request message may be generated by an access device or a server and may be sent to an issuing financial institution directly or through a payment network.

As used herein, the term “communication” and “communicate” refer to the receipt or transfer of one or more signals, messages, calls, commands, or other type of data. For one unit (e.g., any device, system, or component thereof) to be in communication with another unit means that the one unit is able to receive data from and/or transmit data to the other unit. A communication may use a direct or indirect connection and may be wired and/or wireless in nature. Additionally, two units may be in communication with each other even though the data transmitted may be modified, processed, routed, etc., between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

A “communication channel” may refer to any suitable path for communication between two or more entities. Any suitable communications protocols may be used for generating a communications channel. A communication channel may in some instance comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range.

As used herein, the term “computing device” may refer to one or more electronic devices that are configured to process data, such as one or more processors. The computing device may be a client device, an access device, a mobile device, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device also need not be a mobile device, and may be stationary, such as a desktop computer, workstation, or server. Furthermore, the term “computer” may refer to any computing device that includes the necessary components to receive, process, and output data, and normally includes a display, a processor, a memory, an input device, and a network interface.

As used herein, the term “credential” may refer to any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like). The payment device may further include an integrated circuit chip capable of contact-based or contactless communication.

As used herein, the term “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

As used herein, the terms “payment token” or “token” may refer to an identifier that is used as a substitute or replacement identifier for an account identifier, such as a PAN. Tokens may be associated with a PAN or other account identifiers in one or more data structures (e.g., one or more databases and/or the like) such that they can be used to conduct a transaction (e.g., a payment transaction) without directly using the account identifier, such as a PAN. In some examples, an account identifier, such as a PAN, may be associated with a plurality of tokens for different individuals, different uses, and/or different purposes. For example, a payment token may include a series of numeric and/or alphanumeric characters that may be used as a substitute for an original account identifier. For example, a payment token “4900 0000 0000 0001” may be used in place of a PAN “4147 0900 0000 1234.” In some non-limiting examples, a payment token may be “format preserving” and may have a numeric format that conforms to the account identifiers used in existing payment processing networks (e.g., ISO 8583 financial transaction message format). In some non-limiting examples, a payment token may be used in place of a PAN to initiate, authorize, settle, or resolve a payment transaction or represent the original credential in other systems where the original credential would typically be provided. In some non-limiting examples, a token value may be generated such that the recovery of the original PAN or other account identifier from the token value may not be computationally derived (e.g., with a one-way hash or other cryptographic function). Further, in some non-limiting examples, the token format may be configured to allow the entity receiving the payment token to identify it as a payment token and recognize the entity that issued the token.

As used herein, the term “token vault” may refer to a repository that maintains established token-to-PAN mappings. For example, the token vault may also maintain other attributes of the token requestor that may be determined at the time of registration and/or that may be used by the token service provider to apply domain restrictions or other controls during transaction processing. In some non-limiting examples, the token vault may be a part of a token service system. For example, the token vault may be provided as a part of the token service provider. Additionally or alternatively, the token vault may be a remote repository accessible by the token service provider. In some non-limiting examples, token vaults, due to the sensitive nature of the data mappings that are stored and managed therein, may be protected by strong underlying physical and logical security. Additionally or alternatively, a token vault may be operated by any suitable entity, including a payment network, an issuer, clearing houses, other financial institutions, transaction service providers, and/or the like.

As used herein, the term “server” may include one or more computing devices, which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server that is recited as performing a first step or function may refer to the same or different server recited as performing a second step or function.

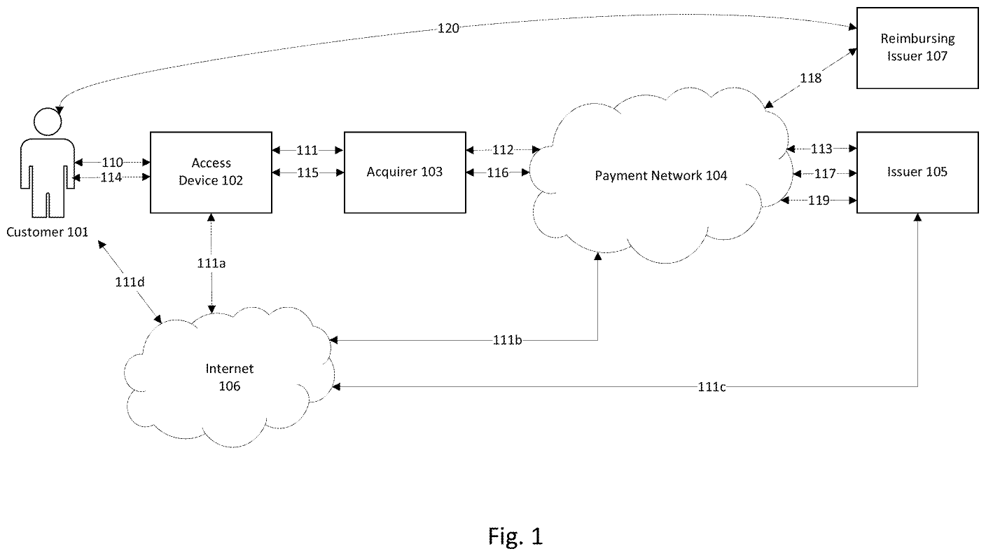

Turning now to the figures, FIG. 1 depicts an illustrative non-limiting example of a system for conducting a multiple account transaction in accordance with some non-limiting examples or aspects of the present disclosure. In some non-limiting examples or aspects the system may include a customer 101, an access device 102, an acquirer 103, a payment network 104, an issuer 105, Internet 106, and reimbursing issuer 107. It should be appreciated by a person of skill in the art that there are many possible configurations for such systems, and that such systems could contain fewer or more entities, each of wish may perform some or all of the tasks of the others, may comprise one or more servers, and each system or component may be owned or operated by various entities, including merchants, payment networks, governments, and financial institutions. As such, FIG. 1 depicts only one illustrative non-limiting example of such a system. Communications between entities in FIG. 1 are shown as bi-directional as they may involve data exchanged to and from entities, such as, for example, a request message and a response message.

In some non-limiting examples or aspects, customer 101 may be the holder of a first account, and may wish to purchase one or more items from a merchant operating access device 102. Customer 101 may communicate with an access device 102 and attempt to perform a transaction using a payment device. At 110, in some non-limiting examples or aspects, customer 101 may present a payment device to access device 102 to initiate a payment transaction. Such presentment may further include communication of account credentials which may occur via wireless communication/interrogation, the reading of a contact-based EMV integrated circuit chip located on a payment device, the “swiping” of a magnetic stripe through a reader, or any other suitable interaction. In some non-limiting examples or aspects, access device 102 may interrogate or read the payment device presented by customer 101 to obtain account credentials comprising a first account number. Alternatively, the payment device may initiate the transmission of account credentials, comprising a first account number, to access device 102. As part of such interrogation or initiation, access device 102 may retrieve account credentials from a secure memory of the payment device presented by customer 101.

Upon receiving a first account number, access device 102 may generate and send a multiple account eligibility check request message comprising the first account number to determine whether the first account number is eligible or configured for association or transaction with one or more additional accounts. Such sending may occur at either 111 or 111a, depending upon whether such request is to be sent via the public Internet 106 or directly to acquirer 103, payment network 104, or issuer 105 via a private network or direct, point-to-point communication channel. In the case in which the multiple account eligibility check request message is sent via a public communication channel, such as Internet 106, the multiple account eligibility check request message may be routed to payment network 104 at 111b, or to issuer 105 at 111c. In the case in which the multiple account eligibility check request message is sent via traditional payment communication channels, access device 102 may send the multiple account eligibility check request via acquirer 103 at 111 and 112 to payment network 104. Because payment network 104 or issuer 105 may perform a multiple account eligibility check, for a given account number, either of these entities may generate and send a response to access device 102 indicating whether the first account number corresponds to a second account as shown at 113 and 112 respectively. The bi-directional arrows depicted at 111, 112, and 113 therefore indicate the transmission of the multiple eligibility check request from access device 102 and the associated response from issuer 105 or payment network 104 as sent through acquirer 103.

Access device 102 may receive confirmation of multiple account eligibility via a message transmitted from payment network 104 or issuer 105, which can occur over Internet 106 at 111b or 111c and subsequently, 111a. In some non-limiting examples or aspects, such multiple account eligibility confirmation may also be transmitted to access device 102 via traditional payment communication channels at 113, 112, and subsequently, 111. The received multiple eligibility confirmation message may also contain at least one multiple account identifier corresponding to one or more second accounts indicating that a second account number is associated with the first account number. Upon receipt of the multiple account eligibility confirmation message, access device 102 may display on a display screen or otherwise output a multiple account identifier corresponding to a second account which is associated with the first account number. At 114, customer 101 may then select the second account on access device 102 using any suitable input mechanism. In some non-limiting examples, at 114, instead of selecting a second account, customer 101 may choose to link an additional account by providing account information for the account to be linked to access device 102. Upon receiving the selection for the second account (or the newly provided unlinked account), access device 102 may generate an authorization request message containing data specific to the intended transaction, some non-limiting examples of which may include an account number for the second account (or representation thereof), a transaction amount, a reimbursement amount, a cryptogram, a multiple account transaction flag, and/or other relevant data. In some non-limiting examples, the authorization request message may be formatted according to the ISO 8583 financial messaging standard. If customer 101 provides a new or additional account at 114, the authorization request message that access device 102 generates may contain an instruction for payment network 104 to store a linkage between the newly provided account and the first account number that was presented at 110.

In some non-limiting examples, instead of selecting a second account on access device 102, customer 101 may instead receive an out-of-band notification on a smartphone or other electronic device informing customer 101 of confirmation of multiple account eligibility, and permitting selection of a second account, as shown at 111d. Such a configuration may be beneficial in cases where access device 102 lacks the technical capability or support to offer selection and use of a second account to perform a multiple payment account transaction in accordance with the other techniques described herein. Upon selection of a second account at 111d, customer 101's choice could be communicated back to payment network 104 or issuer 105 at 111b and 111c, respectively. In such instances, access device 102 may proceed with generating an authorization request message containing data specific to the intended transaction, as described in the preceding paragraph. A potential benefit of such non-limiting examples is that customer 101 need not make the selection prior to or contemporaneous with the completion of the transaction, and could make the selection long after the transaction is authorized, cleared, and settled.

During the course of conducting a transaction, access device 102 may optionally determine whether a specific item is eligible for a multiple account transaction. Non-limiting examples of information specific to such items are stock-keeping unit (“SKU”) data and universal product code (“UPC”) data, which can be “read,” scanned, or entered into access device 102 during a transaction. In some non-limiting examples, access device 102 may determine, or may utilize a server to determine, whether such items are eligible for a multiple account transaction. Such determination may be accomplished through the use of an inventory information approval system (“HAS”), which may be hosted on-site or off-site by a merchant or any other suitable entity. Based on that determination, access device 102 may determine a reimbursement amount that may be less than or equal to the total transaction amount for the purchase transaction.

At 115, access device 102 may send the authorization request message to a server operated by acquirer 103, which may be a financial institution at which a merchant operating access device 102 maintains an account. At 116, acquirer 103 may route the authorization request message to a payment network 104, depending upon the account credentials and/or other data corresponding to a merchant or access device 102. At 117, payment network 104 may then forward the authorization request message to a server operated by issuer 105 for authorization approval or decline. Issuer 105 may host one or more accounts owned by customer 101. In response to the authorization request message, issuer 105 may approve or decline the transaction, and may generate an authorization response message, which may, in some non-limiting examples, be formatted according to the ISO 8583 messaging standard. At 117, issuer 105 may transmit the authorization response message to payment network 104, which may then transmit the authorization response message to access device 102 through acquirer 103 at 116 and 115.

After the transaction has been authorized, reimbursing issuer 107 may be contacted to provide reimbursement for any debits made against an account held at issuer 105. At 118, payment network 104 may send a pull funds request message to reimbursing issuer 107 in order to “pull” funds from reimbursing issuer 107. One non-limiting example of such a pull funds request is an Account Funding Transaction (“AFT”) debit message. Payment network 104 may then “push” such funds to issuer 105 using a push funds message at 119. One non-limiting example of such a push funds transaction is an Original Credit Transaction (“OCT”) message, such as that used by Visa, Inc. in its Visa Direct product. The aforementioned “pull” and “push” funds transactions may be conducted for a specified reimbursement amount that corresponds to the total price or value of the eligible items purchased, which may be less than or equal to the total transaction amount. The reimbursement transactions may also be orchestrated through one or more calls to an application programming interface (“API”) hosted by payment network 104, reimbursing issuer 107, issuer 105, or any other suitable entity. In some non-limiting examples or aspects, payment network 104 may instruct reimbursing issuer 107 to push funds to issuer 105 or to otherwise coordinate reimbursement. Upon receipt of an instruction to remit funds to issuer 105, reimbursing issuer 107 may also verify the authenticity of that instruction. Such verification may involve confirming with payment network 104 upon receiving the instruction at 118, and/or may entail verifying the instruction with customer 101, as shown at 120, that such reimbursement is authorized and desired. Verification 120 may occur through any suitable communication channel, including SMS, voice phone call, Internet communication (such as via Internet 106), or any other suitable technique.

It should be appreciated by persons of skill in the part that use of AFT/OCT transactions generally assumes that reimbursing issuer 107 and issuer 105 are different entities. In that situation, the AFT/OCT transactions may provide a convenient mechanism for money transfer. If reimbursing issuer 107 and issuer 105 are the same entity, it is possible for that entity to perform an internal “on-us” credit posting to credit funds to customer 101's payment card account. Nevertheless, it is entirely possible that when reimbursing issuer 107 and issuer 105 are the same entity, that entity will still choose to execute an AFT or OCT transaction (or both) rather than use their internal systems. This situation can occur if it is more difficult for the bank to connect internal systems than it is to execute an AFT/OCT transaction. In some non-limiting examples, reimbursing issuer 107 and issuer 105 may handle funds transfer through networks and systems separate from payment network 104, such as Fedwire, the Clearing House Interbank Payments System (“CHIPS”), the Society for Worldwide Interbank Financial Telecommunication (“SWIFT”), or any other suitable technique. In some non-limiting examples, if issuer 105 maintains its own account at reimbursing issuer 107, reimbursement can occur through a deposit into that account occurring entirely within reimbursing issuer 107.

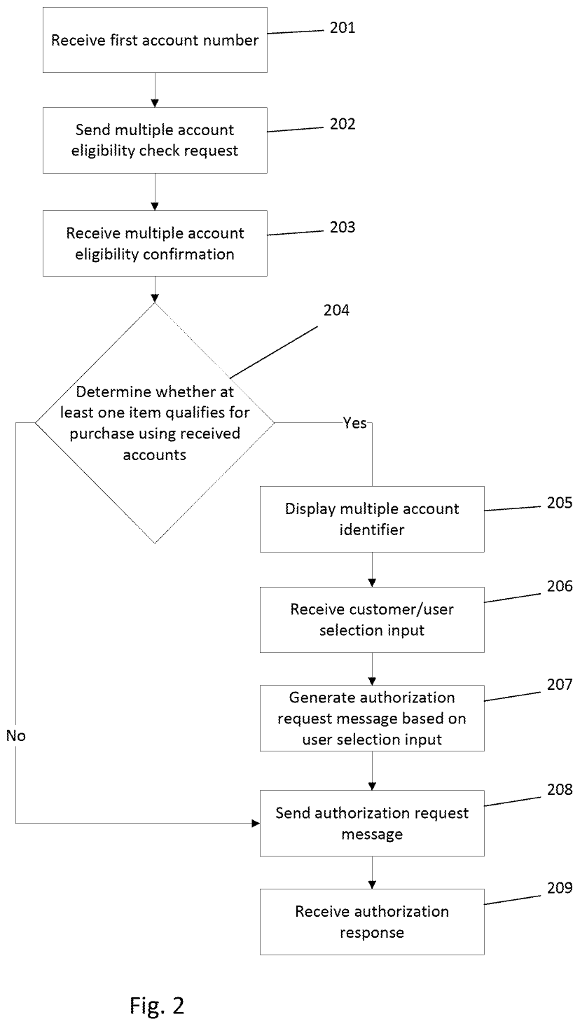

Turning now to FIG. 2, an illustrative non-limiting example of a decision tree for implementing a system, method, and/or process in accordance with some non-limiting examples or aspects of the present disclosure is depicted. In some non-limiting examples, the decision tree depicted in FIG. 2 may be performed by a merchant's access device. At step 201, the access device may receive a first account number from a cardholder as part of a payment transaction. This may occur by presentment of a payment device to this access device via contact or contactless transmission, through the reading of a mag-stripe, or through any other suitable technique. At step 202, a multiple account eligibility check request may be transmitted from an access device to a payment network or other entity capable of determining whether the first account number received at step 201 is eligible for performing a transaction that will be reimbursed or underwritten by another account. Such an eligibility check may also include determining whether another account has been linked to or associated with the first account number. At step 203, an access device may receive a multiple account eligibility confirmation message indicative of whether the first account number is enrolled in and/or eligible for a multiple account transaction. The information received at step 203 may include one or more multiple account identifiers associated with accounts linked to the first account number. The multiple account identifiers may also be a second account number associated with the first account number or may be an indicator that the second account number is associated with the first account number.

At step 204, a determination may be made of whether at least one item intended for purchase qualifies for a multiple account transaction. Step 204 may be relevant where only certain classes of items sold by a merchant are eligible, as can be the case with a healthcare flexible spending accounts (“FSA”) or an electronic benefit account (“EBT”), or other types of accounts where the particular item being purchased in the transaction is relevant to consideration for reimbursement. It should be appreciated by persons of skill in the art that step 204 may actually be performed earlier in the process. If no items qualify, then the payment transaction may proceed as a normal: generating and sending an authorization request message as shown at step 208, and receiving an authorization response at step 209. The authorization request message may be sent to an acquirer, and then forwarded to a payment network, and ultimately, to the issuer corresponding to the first account number, which may respond to the request with an authorization response message. The authorization request and response messages may be formatted according to the ISO 8583 messaging standard. If at least one item qualifies for a multiple account transaction, then proceeding to step 205, at least one multiple account identifier may be displayed or otherwise output by the access device.

Step 205 may include displaying or outputting at least one multiple account identifier on an access device for selection by a customer/user, which may be received at step 206 via one or more device inputs. Upon receiving the user selection at step 206, an authorization request message may be generated based on the selection input at step 207. This authorization request message may include a multiple account identifier, and in some non-limiting examples, may comprises a second account number. At step 208, the authorization request message may be sent may be sent to an acquirer, then, forwarded to a payment network, and ultimately, to the issuer corresponding to the first account number, which may respond to the request with an authorization response message, which may be sent to and received by the access device at step 209. At some point after completion of the steps recited in steps depicted in FIG. 2, a payment network may orchestrate funding and/or reimbursement of the authorized transaction. This may occur through may send a pull funds request message to the reimbursing issuer in order to “pull” funds from the reimbursing issuer. One non-limiting example of such a pull funds request is an Account Funding Transaction (“AFT”) debit message. A payment network may then perform or coordinate the “push” of such funds to the issuer that authorized the original transaction, using a push funds message. One non-limiting example of such a push funds transaction is an Original Credit Transaction (“OCT”) message, such as that used by Visa, Inc. in its Visa Direct product offering.

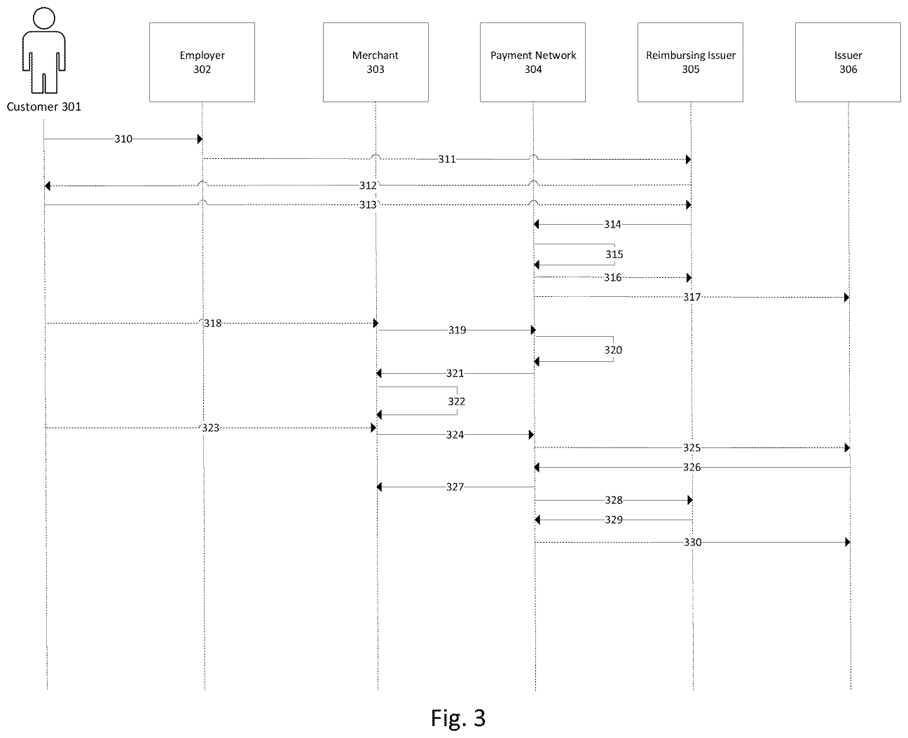

Turning now to FIG. 3, an illustrative non-limiting example of a sequence diagram for implementing a system, method, and/or process in accordance with some non-limiting examples or aspects of the present disclosure is depicted. Steps 310 through 317 provide a non-limiting example of events in account enrollment, setup, and the account linking process, while steps 318 through 327 provide a non-limiting example of a transaction. Steps 329 through 330 illustrate one non-limiting example of a reimbursement of issuer 306 via funds residing at reimbursing issuer 305.

At 310, customer 301 may initiate the enrollment and funding of an account, such as an FSA account, by directing employer 302 to create (and optionally fund) an account at reimbursing issuer 305, as depicted at 311. Reimbursing issuer 305 may optionally issue a payment card to customer 301 at 312 and/or inform customer 301 that the account has been created, and customer 301 may activate such a card and/or the associated account at 313. Additionally, at 313 customer 301 may “link” or associate the newly created reimbursement account with an existing payment account, such as a Visa credit or debit card account issued by issuer 306. This linking may occur through customer-initiated communications or interactions with reimbursing issuer 305 and issuer 306, although it may also involve communications with payment network 304. At 314, reimbursing issuer 305 may inform payment network 304 of customer 301's request to link a pre-existing payment account with the newly created reimbursement account. Such linking may occur at 315, wherein payment network 304 may create a mapping or association between the two payment accounts and their corresponding account numbers in a table, database record, or any suitable data structure. This association can be stored at any suitable entity, including a token vault, if payment network 304 operates such a vault for tokenizing account numbers. At 316 and 317, payment network 304 may inform reimbursing issuer 305 and issuer 306 that the accounts are linked.

At 318, customer 301 may attempt to perform a transaction at a merchant 303 using a pre-existing or first account issued by issuer 306. At 319, merchant 303 may, through an access device, generate and send a multiple account eligibility check request to payment network 304. At 320, payment network 304 may determine whether the first account is associated with a second account which may be used for reimbursement of the transaction. At 321, payment network 304 may send a multiple account eligibility confirmation message to merchant 303 comprising a multiple account identifier, which may be information relating to one or more associated or “linked” account(s). At 322, merchant 303 may output via an access device linked accounts for performing a multiple account transaction. At 323, customer 301 may select a linked account for performing a multiple account transaction. At 324, an access device at merchant 303 may generate and send to payment network 304 an authorization request message which may comprise a transaction amount, a reimbursement amount, and a multiple account transaction flag, which may indicate a selected second account for transacting. In some non-limiting examples or aspects, the multiple account transaction flag may also contain the same value as, or may be, the multiple account identifier or an account number corresponding to the second account for reimbursement. In some non-limiting examples or aspects, the multiple account transaction flag may be a Boolean or binary value and may be “set” to “TRUE” or “1,” indicative of a customer/cardholder's desire for reimbursement using the selected second account. Alternatively, in some non-limiting examples or aspects, the multiple transaction flag may simply be an integer value corresponding to the reimbursement amount. Payment network 304 may then forward the authorization request message to issuer 306 for authorization at 325, and at 326, issuer 306 may send an authorization response message indicating whether a transaction is approved or declined. Payment network 304 may forward the authorization response message to the access device at merchant 303 at 327.

Upon authorization approval, payment network 304 may begin a clearing and settlement process, and may seek reimbursement of all or part of the transaction from reimbursing issuer 305. In some non-limiting examples, clearing and settlement may occur as normal, with issuer 306 delivering funds to an acquiring bank associated with merchant 303. Either as part of or independent from such clearing and settlement processes, payment network 304 may attempt to obtain funds from reimbursing issuer 305 to provide such funds to issuer 306 for a multiple account transaction. In some non-limiting examples, payment network 304 may initiate an account funding transaction (“AFT”) at 328 to “pull” funds from reimbursing issuer 305 at 329 for reimbursement of issuer 306, and may “push” such funds to issuer 306 at 330 using any suitable method, a non-limiting example of which may be a Visa Original Credit Transaction (“OCT’) push operation. In some non-limiting examples, payment network 304 may instruct reimbursing issuer 305 to send funds to issuer 306 using any suitable funds transfer technique.

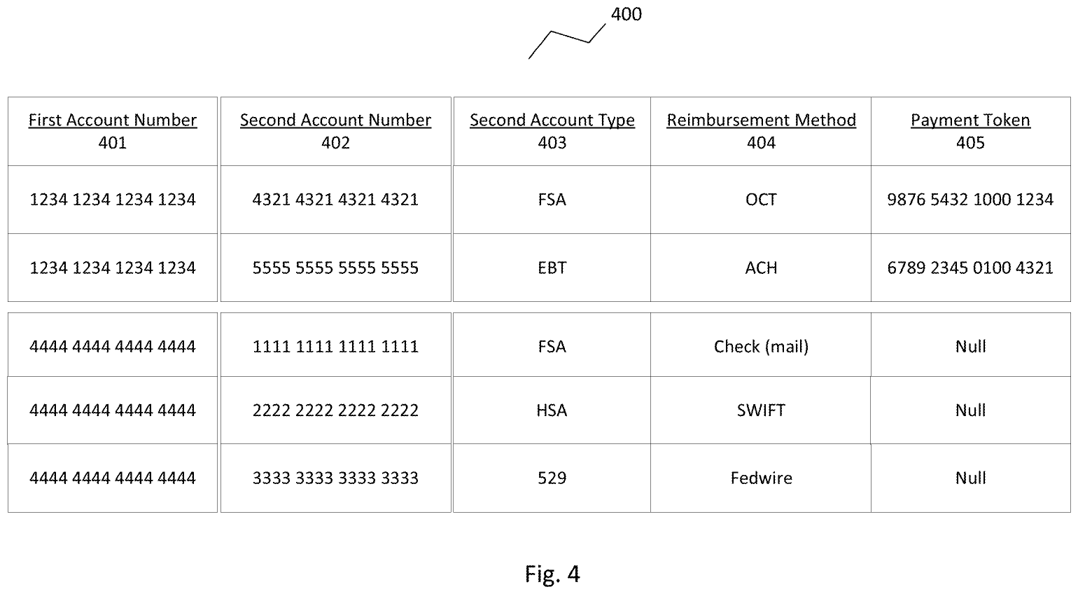

Turning now to FIG. 4, an illustrative non-limiting example of an association between a first account number, a second account number, and an associated account type and reimbursement method is depicted. In some non-limiting examples, the associations between such information may be stored electronically in a table, relational database, or in any other suitable data structure, and may reside in the server(s) of a payment network, issuer, acquirer, merchant, or any other suitable entity, including servers such as a token vault. Table 400 is a non-limiting example of such a data structure. Upon receiving a multiple account eligibility check request, the server hosting table 400 may search table 400, or its index or keys, to determine whether a first account is associated with a second account, and may respond accordingly by sending the corresponding second account number 402, or a subset or representation thereof.

First account number 401 and second account number 402 may correspond to any type of financial accounts, and may be formatted according to any numbering standard, some non-limiting examples of which may include: ISO/IEC 7812, ISO 9362, or any other suitable numbering scheme. In some non-limiting examples, first account number 401 may correspond to the account with which a transaction is conducted, while second account number 402 may correspond to the account from which reimbursements are paid. In some non-limiting examples, table 400 may be hosted or operated by or within a token vault. In such non-limiting examples, first account number 401 may be associated with a payment token 405, such that transactions may be tokenized, thereby enabling a cardholder/consumer to initiate a transaction using payment token 405, thus adding an additional layer of security to payment transactions by avoiding the transmission and handling of the underlying payment account credential, first account number 401. Second account type 403 may specify the type of account utilized for reimbursement in a transaction. Some non-limiting examples of such accounts may include healthcare flexible spending accounts (“FSAs”), health savings accounts (“HSAs”), electronic benefit transfer accounts (“EBTs”), education savings plan accounts, retirement accounts, and accounts that do not issue individual payment cards.

Reimbursement method 404 may specify the type of funds transfer operation or protocol that may be used to perform a reimbursement from a second account to a first account. Some non-limiting examples of such methods may include a Visa Original Credit Transaction (“OCT”), an Automated Clearing House (“ACH”) transaction, SWIFT, a “wire” transfer via Fedwire or the Clearing House Interbank Payments System (“CHIPS”), a physical check sent via postal mail, or any other suitable technique. In some non-limiting examples in which table 400 is hosted by a payment network, at some point during or after a transaction's authorization, a payment network may initiate a reimbursement transaction from the account corresponding to second account number 402, to ensure reimbursement of the account corresponding to first account number 401. It should be appreciated by persons of skill in the art that each “row” depicted in table 400 can be considered a “record,” such that the data items contained in each “column” of such row are all associated. It should further be appreciated that the columns depicted in table 400 are not exhaustive, nor are they all required to implement the features described herein.

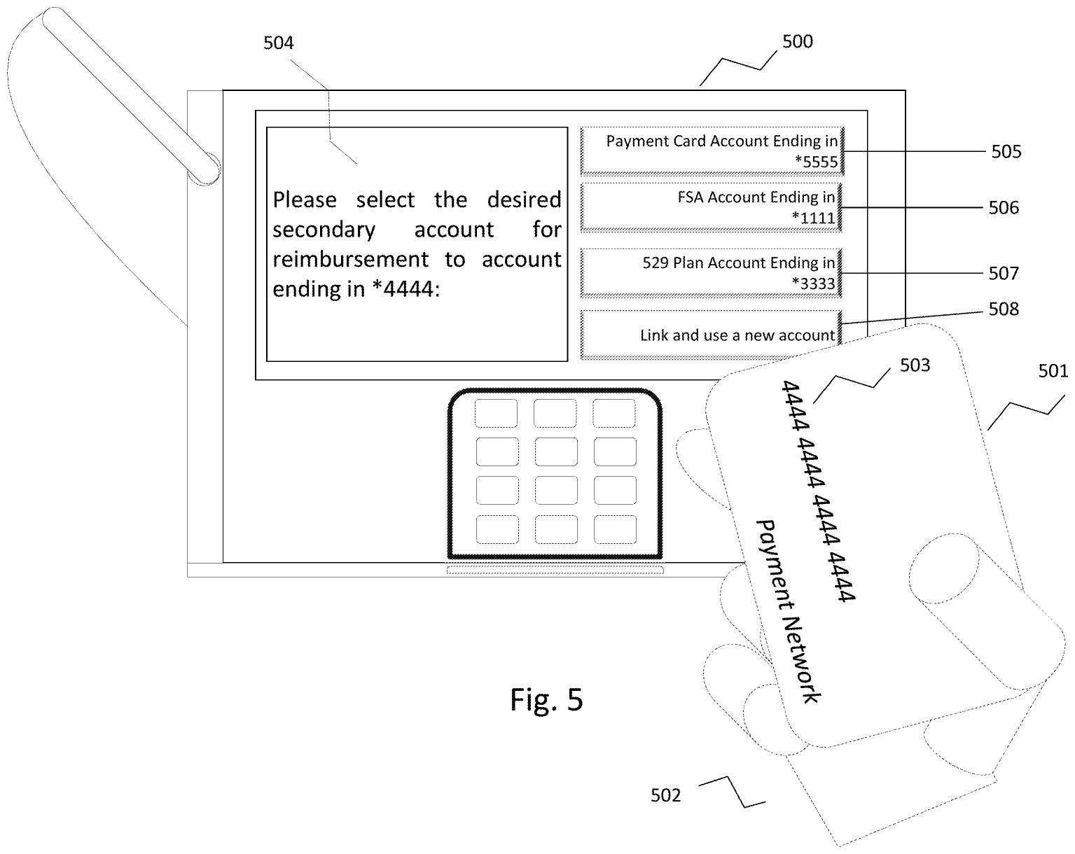

Turning now to FIG. 5, an illustrative non-limiting example of a user interface displayed on an access device when conducting a multiple account transaction in accordance with some non-limiting examples or aspects of the present disclosure is depicted. Customer/account holder 502 may present payment device 501 to access device 500 to initiate a payment transaction. It should be appreciated by a person of skill in the art that numerous presentment methods are possible, and are described in detail above in the description of FIG. 1. Payment device 501 may be associated with, and may bear a marking of, first account number 503, which may correspond to a payment card account issued by an issuing bank and capable of transacting using a payment network, a non-limiting example of which is VisaNet, operated by Visa, Inc.

In some non-limiting examples, when payment device 501 is presented to and interacts with access device 500, access device 500 generates and sends a multiple account eligibility check request message comprising first account number 503. In some non-limiting examples, access device 500 may send the multiple account eligibility check request message via a public communication channel, such as the Internet, or via a direct, point-to-point communication channel to an acquiring bank or other entity. In some non-limiting examples, the multiple account eligibility check request message may contain information specific to the types of items to be purchased. Alternatively, and as previously discussed in the description of FIG. 1, access device 500 may separately determine whether a specific item is eligible for a multiple account transaction, independent of the multiple account eligibility check request. Non-limiting examples of information specific to such items are stock-keeping unit (“SKU”) data and universal product code (“UPC”) data, which can be “read” or entered into access device 500 during a transaction. In some non-limiting examples, access device 500 may determine, or may utilize a server to determine, whether such items are eligible for a multiple account transaction. Such determination may be accomplished through the use of an inventory information approval system (“IIAS”).

Upon receipt of the multiple account eligibility check request message, a payment network or other entity may determine whether first account number 503 is associated with one or more second accounts for reimbursement transactions. Based upon that determination, a multiple account eligibility confirmation message may be sent to access device 500, which may comprise a multiple account identifier corresponding to the second account(s).

Access device 500 may display or otherwise output options for customer selection corresponding to one or more multiple account identifiers, or other information associated with the second accounts, such as those depicted at 505, 506, and 507. Access device 500 may be capable of receiving input from a user, such as customer/account holder 502, using any manner of device inputs, including tactile/touch-screen input, keypad entry, voice commands, or any other suitable technique. Customer/account holder 502 may provide selection input via access device 500. Upon selection by customer/account holder 502, access device 500 may generate and send an authorization request message based upon the selected second account. As with the multiple eligibility check request message, the authorization request message may be sent via any available communication channel, including over the public Internet or via a private or point-to-point communication to an acquiring bank, payment network, or any other suitable entity. In some non-limiting examples, the authorization request message may comprise a transaction amount, a reimbursement amount, and a multiple account transaction flag, which may also be the multiple account identifier. The multiple account transaction flag may be used to inform a payment network that a transaction conducted using a first account (such as account number 503) should be reimbursed via funds obtained from a second account, such as the account selected by customer/account holder 502, including those depicted at 505, 506, and/or 507. The multiple account transaction flag may also indicate an amount of the transaction intended for reimbursement if only a subset of the items being purchased are eligible for a multiple account transaction. Upon sending the authorization request message, access device 500 may receive an authorization response message indicating whether the transaction was approved or declined. The authorization request and authorization response messages may be formatted according to any known messaging protocol, including the ISO 8583 standard specification.

In some non-limiting examples, a customer may wish to use an unlinked account to perform the reimbursement operation. Customer/account holder 502 may select button 508 on access device 500, during which, customer/account holder 502 may provide information relating to an unlinked payment account (different from account number 503), or may present a payment device such as a payment card or smartphone. Such presentment may further include communication of account credentials which may occur via wireless communication/interrogation, the reading of a contact-based EMV integrated circuit chip located on a payment device, the “swiping” of a magnetic stripe through a reader, or any other suitable interaction. Access device 500 may then may generate and send an authorization request message based upon the selected second account. In some non-limiting examples, the authorization request message may comprise a transaction amount, a reimbursement amount, and a multiple account transaction flag, which may also be the multiple account identifier. The multiple account transaction flag may be used to inform a payment network that a transaction conducted using a first account (such as account number 503) should be reimbursed via funds obtained from a second account, such as the unlinked account provided in the course of the transaction. The payment network or issuer may optionally store a linkage between the first account and the unlinked account for future transactions.

It should be appreciated by a person of skill in the art that the menu and options displayed on access device 500 at 504, 505, 506, 507, and 508 may also or instead be displayed on a customer's smartphone or other electronic device, thus allowing customer/account holder 502 to perform similar selections on their own device and provide such selection to a payment network or issuer. Such interactions could occur out-of-band and over an Internet connection by messages directed to such devices, therefore, outside of traditional transaction messages.

It should be understood and appreciated by a person of skill in the art that nothing in the above is intended to limit the functionality and structures described herein. The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents. One or more features from any non-limiting examples or aspects may be combined with one or more features of any other example or aspect without departing from the scope of the disclosure. A recitation of “a”, “an” or “the” is intended to mean “one or more” unless specifically indicated to the contrary. All patents, patent applications, publications, and descriptions mentioned above are herein incorporated by reference in their entirety for all purposes. None is admitted to be prior art.

What is claimed is:

1. A multiple account transaction method, comprising:
receiving, by an access device, a first account number;
sending, by the access device, a multiple account eligibility check request message comprising the first account number;
receiving, by the access device, a multiple account eligibility confirmation message comprising at least one multiple account identifier;
displaying, by the access device, the at least one multiple account identifier;
receiving, by the access device, a selection input;
generating, by the access device, an authorization request message based upon the selection input, wherein the authorization request message comprises a multiple account transaction flag and a transaction amount;
sending, by the access device, the authorization request message; and
receiving, by the access device, an authorization response message.

2. The method of claim 1, wherein the at least one multiple account identifier is an indicator that a second account number is associated with the first account number.

3. The method of claim 2, wherein the second account number corresponds to at least one of a healthcare flexible spending account (“FSA”), a health savings account (“HSA”), an electronic benefit transfer account (“EBT”), an education savings plan account, or any combination thereof.

4. The method of claim 3, further comprising determining whether an item is eligible for purchase using the second account number.

5. The method of claim 4, wherein the authorization request message further comprises a reimbursement amount that is less than or equal to the transaction amount.

6. The method of claim 1, wherein the at least one multiple account identifier is the multiple account transaction flag.

7. The method of claim 1, wherein the authorization request message and the authorization response message are formatted according to a messaging specification, as defined in ISO 8583.

8. The method of claim 1, wherein the step of receiving, by the access device, the first account number, comprises performing an interaction between a payment device and the access device.

9. The method of claim 8, wherein the interaction comprises at least one of reading a magnetic stripe of the payment device, reading an integrated circuit of the payment device, communicating wirelessly with the payment device, or any combination thereof.

10. A multiple account transaction method, comprising:
receiving, by a payment network, a multiple account eligibility check request message comprising a first account number associated with a first account;
determining, by the payment network, whether the first account is eligible for multiple account transactions with a second account number associated with a second account;
sending, by the payment network, a multiple account transaction eligibility confirmation message;
receiving, by the payment network, an authorization request message for a transaction including a multiple account transaction flag and a reimbursement amount;
sending, by the payment network, the authorization request message to an issuer;
receiving, by the payment network, an authorization response message; and
forwarding, by the payment network, the authorization response message to an access device; and
in response to the authorization response message indicating transaction approval: executing, by the payment network, a pull funds operation from the second account for the reimbursement amount; and
executing, by the payment network, a push funds operation to the first account for the reimbursement amount.

11. The method of claim 10, wherein the first account and the second account are both associated with an account holder.

12. The method of claim 10, wherein the authorization request message and the authorization response message are formatted according to a messaging specification, as defined in ISO 8583.

13. The method of claim 10, further comprising retrieving, by the payment network, the second account number when the multiple account transaction flag is set.

14. The method of claim 10, wherein the pull funds operation is an account funding transaction (“AFT”) and the push funds operation is an original credit transaction (“OCT”).

15. The method of claim 10, wherein the second account is at least one of a healthcare flexible spending account (“FSA”), a health savings account (“HSA”), an electronic benefit account (“EBT”), an education savings plan account, or any combination thereof.

16. The method of claim 15, further comprising determining whether an item associated with the transaction is eligible for purchase using the second account.

17. A system for performing a multiple account transaction method, the system comprising:
an access device; and
a payment network configured to:
receive a multiple account eligibility check request message comprising a first account number associated with a first account;
determine whether the first account is eligible for multiple account transactions with a second account number associated with a second account;
send a multiple account transaction eligibility confirmation message comprising at least a multiple account identifier;
receive an authorization request message for a transaction including a multiple account transaction flag;
send the authorization request message to an issuer;
receive an authorization response message;
forward the authorization response message to an access device, and if the authorization response message indicates transaction approval:
execute a pull funds operation from the second account; and
execute a push funds operation to the first account;
wherein the access device is configured to:
receive the first account number associated with the first account;
send the multiple account eligibility check request message comprising the first account number;
receive the multiple account transaction eligibility confirmation message;
display the multiple account identifier;
receive a selection input;
generate the authorization request message based upon the selection input;
send the authorization request message; and
receive an authorization response message.

18. The system of claim 17, wherein the pull funds operation is an account funding transaction (“AFT”) and the push funds operation is an original credit transaction (“OCT”).

19. The system of claim 17, wherein the second account is at least one of a healthcare flexible spending account (“FSA”), a health savings account (“HSA”), an electronic benefit account (“EBT”), an education savings plan account, or any combination thereof.

20. The system of claim 17, wherein the authorization request message and the authorization response message are formatted according to a messaging specification, as defined in ISO 8583.
